(19) United States
(12) Patent Application Publication
(10) Pub. No.: US 2012/0127576 A1
(43) Pub. Date: May 24, 2012

(54) ANTI-VIBRATION ACTUATOR AND LENS UNIT AND CAMERA FURNISHED WITH SAME

(75) Inventor: Yukio TANAKA, Saitama-shi (JP)

(73) Assignee: Tamron Co., Ltd., Saitama-shi (JP)

(21) Appl. No.: 13/296,613

(22) Filed: Nov. 15, 2011

(30) Foreign Application Priority Data
Nov. 19, 2010 (JP) 2010-258540

(51) Int. Cl. G02B 27/64

(52) U.S. Cl. 359/557

(57) ABSTRACT

The present invention is an anti-vibration actuator (1), including: a fixed portion (12); a first movable portion (14) to which an image stabilizing lens (16) is attached, disposed to be movable within a plane perpendicular to an optical axis; a second movable portion (15) disposed to be movable relative to the fixed portion; a movable portion support means (18) for supporting the first or second movable portion; drive means (20, 22) for generating a drive force to move the image stabilizing lens to a predetermined position within a plane perpendicular to the optical axis; and a reverse motion mechanism (17) for moving the second movable portion in a direction opposite the direction in which the image stabilizing lens had been moved when the image stabilizing lens is moved to a predetermined position.

### TECHNICAL FIELD

The present invention relates to an anti-vibration actuator, and more particularly to an anti-vibration actuator for moving an image stabilizing lens, and to a lens unit and camera furnished with same.

### BACKGROUND ART

A vibration compensating optical device is set forth in Unexamined Laid Open Patent 2002-350916 (Patent Citation 1). In this vibration compensating optical device, a support frame to which a compensating lens is attached is movably supported by three support shafts and three compression coil springs. The support frame is driven by a linear motor comprising a coil and a permanent magnet, and serves to compensate for image blurring. In this vibration compensating optical device, when the drive force from the linear motor is stopped, the support frame is restored to essentially its initial position by the biasing force of the compression coil springs, and the optical axis of the compensating lens is brought essentially into conformance with the optical axis of other image capturing lenses.

Unexamined Laid Open Patent 2008-233526 (Patent Citation 2), meanwhile, sets forth an image stabilizing actuator. In this image stabilizing actuator a movable portion, to which an image stabilizing lens is attached, is supported by three steel balls so as to be movable within a plane perpendicular to the optical axis. The movable portion is also moved by a linear motor furnished with a drive coil and a drive magnet. In this image stabilizing actuator, the movable portion is supported by steel balls, therefore rubbing friction is extremely minute when the movable portion is moved, and the image-stabilizing lens can be smoothly moved.

### PRIOR ART REFERENCES

### Patent References

### Patent Citation 1

Unexamined Laid Open Patent 2002-350916

### Patent Citation 2

Unexamined Laid Open Patent 2008-233526

### SUMMARY OF THE INVENTION

### Problems the Invention Seeks to Resolve

In the vibration compensating optical device set forth in Unexamined Laid Open Patent 2002-350916, however, the support frame constantly receives a biasing force from the compression coil springs, therefore the linear motor must drive the support frame against the biasing force arising from the coil springs in order to move the support frame. Moreover, because the biasing force operating on the support frame varies depending on the position to which the support frame is moved, the problem arises that the control characteristics for moving the support frame change depending on the position of the support frame. This leads to the problem that the vibration compensating performance of the vibration compensating optical device declines, particularly at positions at which the support frame is distant from its initial position.

In the image stabilizing actuator set forth in Unexamined Laid Open Patent 2008-233526, the movable portion is supported by steel balls, therefore the resistance force impeding the movement of the movable portion is extremely small. Also, because the resistance force acting on the movable portion does not change according to the position of the movable portion, the problems described above do not arise.

However, in the image stabilizing actuator set forth in Unexamined Laid Open Patent 2008-233526, the movable portion is moved downward by gravity when the linear motor drive force is stopped. Therefore in this image stabilizing actuator drive force must be continuously applied by the linear motor against gravity just to hold the initial position without the image stabilizing lens moving. The problem therefore arises in the image stabilizing actuator set forth in Unexamined Laid Open Patent 2008-233526 that the power consumption needed to operate the actuator becomes significant. Also, in this image stabilizing actuator a drive force to resist gravity must be generated in addition to the drive force used to move the movable portion, leading to the problem that the required drive force is large, thus enlarging the drive means.

Therefore the present invention has the object of providing an anti-vibration actuator and lens unit and camera furnished with same, capable of minimizing power consumption and enabling smooth movement of an image stabilizing lens.

### Means for Resolving Problems

In order to resolve the above-described problems, the present invention is an anti-vibration actuator comprising: a fixed portion; a first movable portion to which an image stabilizing lens is attached, disposed to be movable within a plane perpendicular to an optical axis; a second movable portion disposed to be movable relative to the fixed portion; a movable portion support means for supporting the first movable portion or second movable portion so as to be movable within a plane perpendicular to the optical axis; a drive means for generating a drive force to move the image stabilizing lens to a predetermined position within a plane perpendicular to the optical axis; and a reverse motion mechanism for moving the second movable portion in a direction opposite the direction in which the image stabilizing lens had been moved when the image stabilizing lens is moved to a predetermined position within a plane perpendicular to the optical axis.

In the present invention thus constituted, the first movable portion, to which the image stabilizing lens is attached, is disposed so as to be movable within a plane perpendicular to the optical axis of the image stabilizing lens. Also, the second movable portion is disposed to be movable with respect to the fixed portion. The movable portion support means supports the first movable portion or the second movable portion so as to be movable in a plane perpendicular to the optical axis. The drive means generates a drive force to move the image stabilizing lens to a predetermined position in a plane perpendicular to the optical axis. When the image stabilizing lens is moved to a predetermined position, a reverse motion mechanism moves the second movable portion in a direction opposite the direction in which the image stabilizing lens is moved.

In the present invention thus constituted, the second movable portion is moved by a reverse motion mechanism in the opposite direction to the direction in which the image stabilizing lens was moved. Therefore when the first movable portion to which the image stabilizing lens is attached is pulled downward by gravity, the reverse motion mechanism seeks to lift the second movable portion upward. The gravity acting on the first movable portion therefore cancels out the gravity acting on the second movable portion. The drive force from the drive means needed to hold the image stabilizing lens in a predetermined position against the force of gravity can thus be reduced, and power consumption by the image stabilizing actuator can be minimized.

In the present invention the reverse motion mechanism preferably moves the first movable portion and the second movable portion by approximately the same distance in opposite directions.

In the present invention thus constituted, when the weight of the first movable portion and the second movable portion are approximately equal, the gravity acting on the first movable portion and the gravity acting on the second movable portion are approximately equal, and the drive force from the drive means can be reduced.

In the present invention the first movable portion and the second movable portion preferably have essentially the same mass.

In the present invention thus constituted, the gravity acting on the first movable portion and the gravity acting on the second movable portion are approximately equal, and the drive force from the drive means can be made extremely small.

In the present invention there is preferably furthermore a second image stabilizing lens attached to the second movable portion, and this second image stabilizing lens has the inverse optical power to that of the image stabilizing lens.

In the present invention thus constituted, image stabilizing lenses with an inverse optical power are respectively attached to the first movable portion and second movable portion, which move in mutually opposing directions, thereby permitting the amount of vibration compensation to be increased relative to the movement distance of the movable portion, such that sufficient vibration compensation can be achieved over a smaller motion distance.

In the present invention the reverse motion mechanism is preferably a gear disposed between the first movable portion and the second movable portion.

In the present invention thus constituted, the space between the first movable portion and the second movable portion can be maintained at a predetermined gap as the first movable portion and second movable portion are moved in opposite directions.

In the present invention the reverse motion mechanism is preferably a link mechanism, and the first movable portion and second movable portion are respectively coupled on both sides of the fulcrum of this link mechanism.

In the present invention thus constituted, the reverse motion mechanism can be achieved using a simple structure.

Also, the present invention is a lens unit furnished with an image stabilizing mechanism, having a lens barrel, an image capturing lens disposed within this lens barrel, and the anti-vibration actuator of the present invention.

The present invention is furthermore a camera furnished with an image stabilizing mechanism, having a camera main body and the lens unit of the present invention.

### Effect of the Invention

The anti-vibration actuator and lens unit and camera furnished therewith enable power consumption to be minimized while enabling the smooth movement of an image stabilizing lens.

### BRIEF DESCRIPTION OF FIGURES

FIG. 1

A cross-section of a camera according to a first embodiment of the present invention.

FIG. 2

A side elevation cross-section of an anti-vibration actuator built into the camera according to a first embodiment of the present invention.

FIG. 3

A front elevation of the fixed portion of the anti-vibration actuator in a first embodiment of the present invention.

FIG. 4

A front elevation of the first movable portion of the anti-vibration actuator in a first embodiment of the present invention.

FIG. 5

A front elevation of the first movable portion of the anti-vibration actuator in a second embodiment of the present invention.

FIG. 6

An exploded perspective view of the anti-vibration actuator in a first embodiment of the present invention.

FIG. 7

A perspective view of a gear in a variation of the first embodiment of the present invention.

FIG. 8

An exploded perspective view of the anti-vibration actuator in a second embodiment of the present invention.

FIG. 9

A partial cross-section showing the state of the reverse motion mechanism when a moving frame and a second moving frame in the second embodiment of the present invention are displaced.

FIG. 10

A partial cross-section showing the state of the reverse motion mechanism when a moving frame and a second moving frame in the second embodiment of the present invention are not displaced.

### EMBODIMENTS OF THE INVENTION

Next, referring to the attached drawings, we discuss embodiments of the present invention.

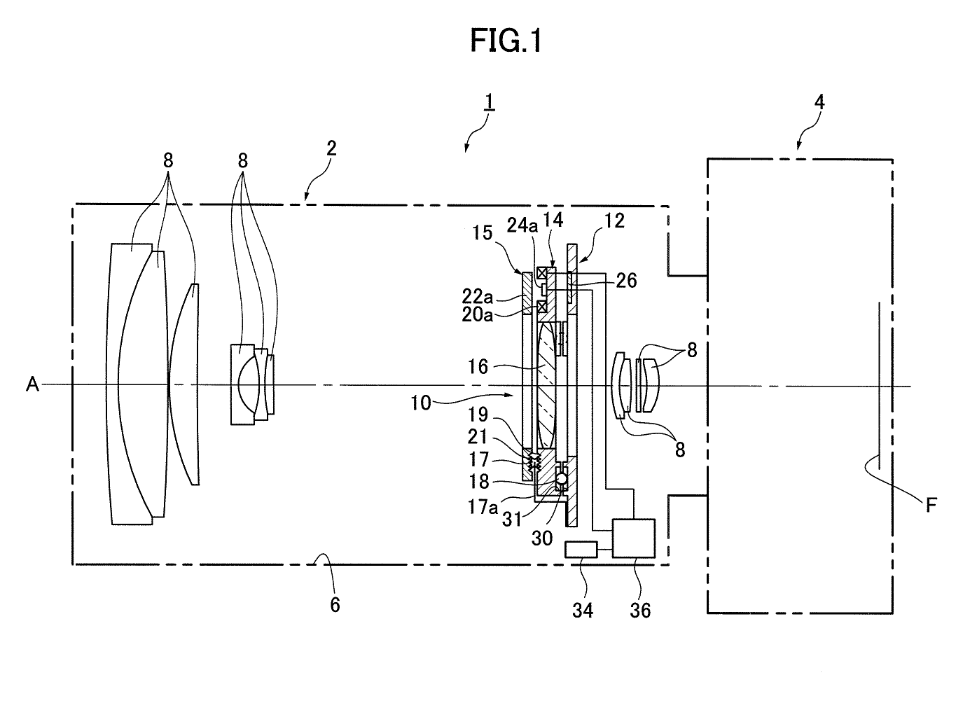

First, referring to FIGS. 1 through 6, we discuss a camera according to a first embodiment of the present invention. FIG. 1 is a cross-section of a camera according to an embodiment of the present invention.

As shown in FIG. 1, the camera 1 of the first embodiment of the present invention has a lens unit 2 and a camera main body 4. The lens unit 2 has a lens barrel 6, multiple imaging lenses 8 disposed within this lens barrel, an anti-vibration actuator 10 for moving the image stabilizing lenses 16 within a predetermined plane, and a gyro 34 serving as vibration detection means for detecting vibration of the lens barrel 6.

The camera 1 of the embodiment of the present invention detects vibration using the gyro 34 and activates the anti-vibration actuator 10 based on detected vibration to move the image stabilizing lenses 16 to stabilize the image focused on film surface F within the camera main body 4. In the present embodiment, a piezo-electric gyro is used as the gyro 34. Note that in the present embodiment the image stabilizing lens is constituted as a single lens, but the lens for stabilizing images can also be a group of multiple lenses. In the present Specification, “image stabilizing lens” includes single lenses and lens sets for stabilizing images.

The lens unit 2 is attached to the camera body 4 so as to focus incident light on the film surface F.

The approximately cylindrical lens barrel 6 holds within it multiple imaging lenses 8, and enables focus adjustment by moving a portion of the imaging lenses 8.

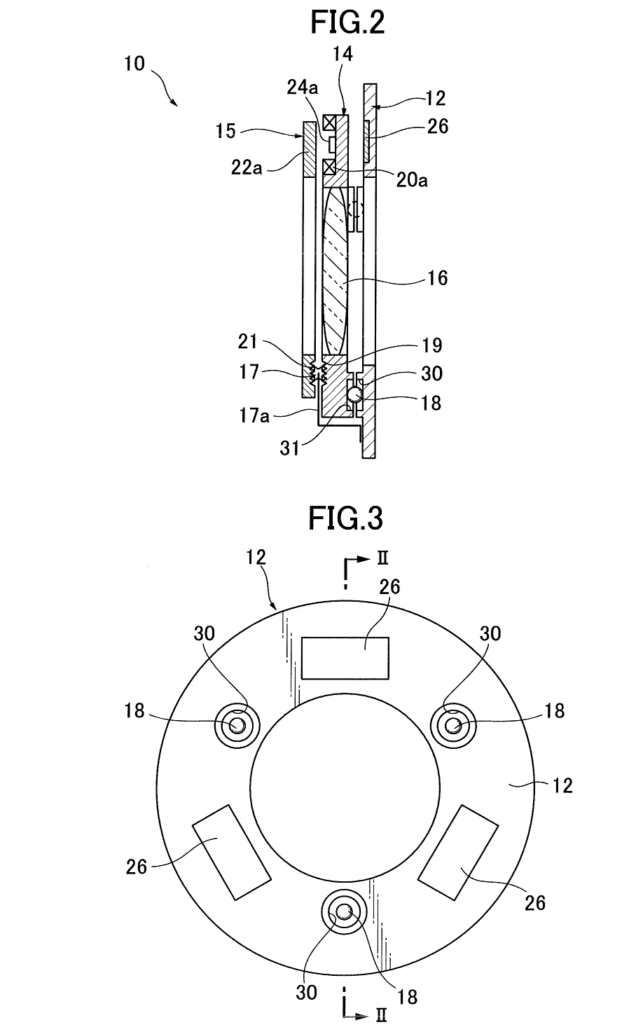

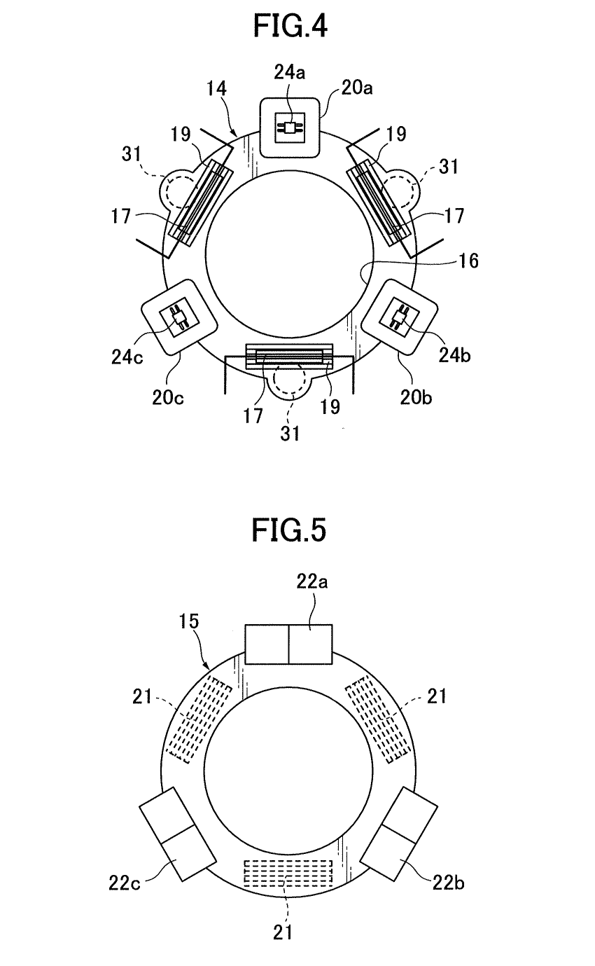

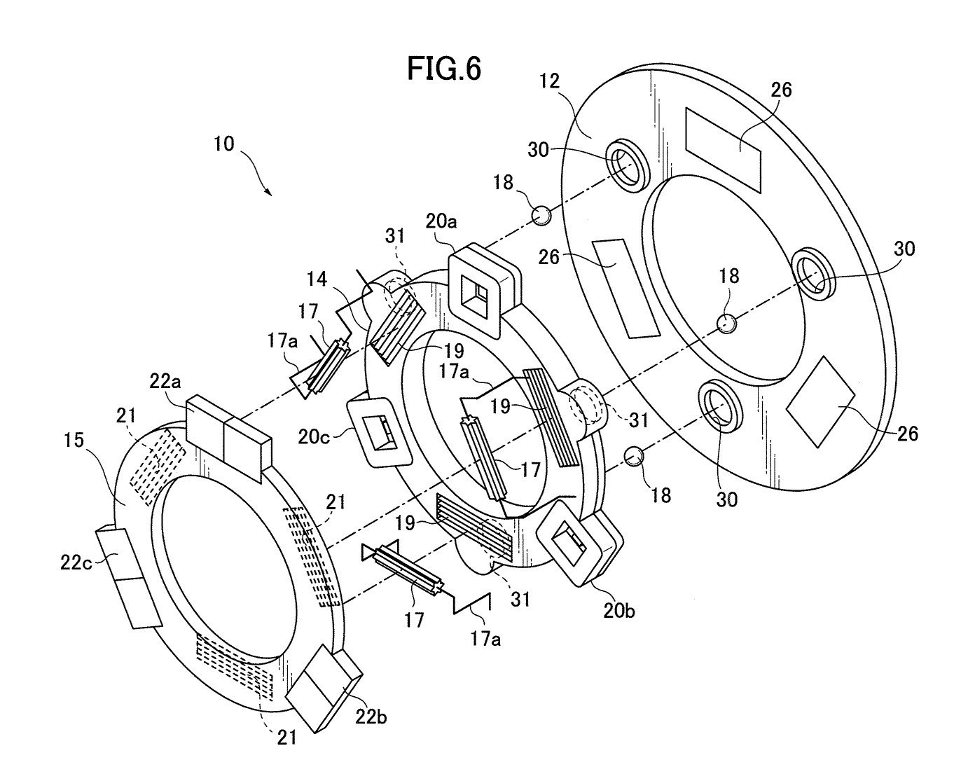

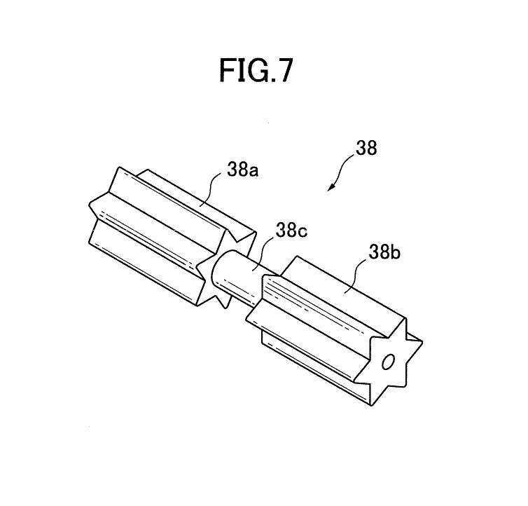

Next, referring to FIGS. 2 through 6, we discuss the anti-vibration actuator 10. FIG. 2 is a side elevation cross-section of the anti-vibration actuator 10. FIG. 3 is a front elevation of the fixed portion of the anti-vibration actuator 10; FIG. 4 is a front elevation of the first movable portion of the anti-vibration actuator 10; and FIG. 5 is a front elevation of the second movable portion of the anti-vibration actuator 10. FIG. 6 is an exploded perspective view of the anti-vibration actuator 10. Note that FIG. 2 is a cross-section showing the anti-vibration actuator 10 split along line II-II in FIG. 3.

As shown in FIGS. 2 through 6, the anti-vibration actuator 10 has a fixed plate 12, which is a fixed portion affixed inside the lens barrel 6; a moving frame 14, which is the first movable portion disposed so as to be capable of translational movement relative to this fixed plate 12; three steel balls 18 serving as movable portion support means for supporting the moving frame 14; a second moving frame 15, which is a second movable portion disposed so as to be movable relative to the fixed plate 12; and three gears 17 serving as a reverse motion mechanism to move the moving frame 14 and the second moving frame 15 in mutually opposite directions.

In addition, the anti-vibration actuator 10 has a first drive coil 20a, second drive coil 20b, and third drive coil 20c attached to the moving frame 14; a first drive magnet 22a, second drive magnet 22b, and third drive magnet 22c attached at positions respectively corresponding to the first drive coils 20a, 20b, and 20c on the second moving frame 15; and a first magnetic sensor 24a, second magnetic sensor 24b, and third magnetic sensor 24c serving as first, second, and third position detecting elements respectively disposed inside each of the drive coils 20a, 20b, and 20c.

The anti-vibration actuator 10 also has three attaching yokes 26 attached to the fixed plate 12 in order to pull in the moving frame 14 and the second moving frame 15 to the fixed plate 12 using the magnetic force of each of the drive magnets. Note that the first drive coil 20a, second drive coil 20b, and third drive coil 20c, and the first drive magnet 22a, second drive magnet 22b, and third drive magnet 22c respectively attached at positions corresponding thereto, respectively form drive mechanisms for generating a drive force between the moving frame 14 and the second moving frame 15 and moving the image stabilizing lens 16 to a predetermined position.

In addition, as shown in FIG. 1, the anti-vibration actuator 10 has a controller 36 serving as control section for controlling the current sourced to first, second, and third drive coils 20a, 20b, and 20c based on the vibration detected by the gyro 34 and on position information for the moving frame 14 detected by the first, second, and third magnetic sensors 24a, 24b, and 24c.

The anti-vibration actuator 10 moves the moving frame 14 translationally in a plane parallel to the film surface F; by so doing it moves the image stabilizing lens 16 attached to the moving frame 14 so that no blurring of the image formed on the film surface F occurs even if the lens barrel 6 vibrates.

The moving frame 14 has an approximately flat donut shape, with the image stabilizing lens 16 attached at the center opening thereof. First, second, and third drive coils 20a, 20b, and 20c are disposed on the moving frame 14. As shown in FIG. 3, the centers of these three drive coils are respectively disposed on the perimeter of a circle centered on the optical axis of the lens unit 2. In the present embodiment, the first drive coil 20a is disposed vertically above on the optical axis, and first drive coil 20a, second drive coil 20b, and third drive coil 20c are disposed at equal intervals, separated by a center angle of 120°.

The windings on the first, second, and third drive coils 20a, 20b, and 20c are respectively wound in an approximately rectangular shape with rounded corners, and one of the center lines thereof is disposed to face in a direction tangential to a circle centered on the optical axis.

Three flat gears 19, respectively engaging the three gears 17, are respectively formed between the drive coils on the moving frame 14. Details of the flat gears 19 are discussed below.

The fixed plate 12 is an approximately flat donut-shaped disk, and the moving frame 14 is disposed in parallel to this fixed plate 12. Three attaching yokes 26 are respectively disposed at positions corresponding to the first, second, and third drive coils 20a, 20b, and 20c on a circle on the fixed plate 12. Each of the attaching yokes 26 is approximately elongated in shape, with a center line bisecting the short sides thereof oriented in the radial direction of a circle centered on the optical axis of the lens unit 2. The second moving frame 15 is pulled onto the fixed plate 12 by the magnetic force exerted by each of the drive magnets on the attaching yokes 26, and the moving frame 14 is thus pressed onto the fixed plate 12.

As shown in FIGS. 2 and 3, the three steel balls 18 are spherical members, sandwiched between the fixed plate 12 and the moving frame 14 and respectively disposed at a center angle interval of 120° on the perimeter of a circle centered on the optical axis A. Steel ball holders 30 are formed on the fixed plate 12 at positions corresponding to each of the steel balls 18. At the same time, steel ball holders 31 are formed on the moving frame 14 at positions corresponding to each of the steel balls 18. Each of the steel balls 18 is disposed at the center of these steel ball holders 30 and 31, where they roll, supporting the moving frame 14 so that the moving frame 14 can move smoothly within a plane perpendicular to the optical axis. Dropping out of the steel balls 18 is also prevented by these steel ball holders 30 and 31. As described below, the second moving frame 15 is pulled onto the fixed plate 12 by drive magnets, therefore the steel balls 18 are sandwiched between the moving frame 14 pressed down by the second moving frame 15, and the fixed plate 12. The moving frame 14 is thus supported on a plane parallel to the fixed plate 12 (the plane parallel to the optical axis A), and translational movement in any desired direction of the moving frame 14 relative to the fixed plate 12 is allowed by the rolling of the steel balls 18 sandwiched therein.

The second moving frame 15 is an approximately flat donut-shaped disk, disposed parallel to the moving frame 14. The first drive magnet 22a, second drive magnet 22b, and third drive magnet 22c are respectively disposed at positions corresponding to first, second, and third drive coils 20a, 20b, and 20c on the circle on the second moving frame 15. The first, second, and third drive magnets are approximately elongated in shape, with a center line bisecting the long sides thereof oriented in the radial direction of a circle centered on the optical axis of the lens unit 2. The second moving frame 15 is pulled onto the fixed plate 12 by the magnetic force exerted by these drive magnets on the attaching yokes 26 attached to the fixed plate 12, and the moving frame 14 is pulled onto the fixed plate 12. The first, second, and third drive magnets 22a, 22b, and 22c are magnetized so that the centerline bisecting the long sides thereof forms a magnetization boundary line. The first, second, and third drive magnets 22a, 22b, and 22c exert magnetism on the first, second, and third drive coils 20a, 20b, and 20c. Thus when current flows in each of the drive coils, drive force is generated in the tangential direction of a circle centered on the optical axis between each of the corresponding drive magnets.

Moreover, three flat gears 21 are formed on the second moving frame 15, and these flat gears 21 are disposed at positions respectively corresponding to the flat gears 19 formed on the moving frame 14. Each of the flat gears 19 and flat gears 21 are formed so that their tooth traces extend in a direction tangential to a circle centered on optical axis A. The gears 17 are sandwiched between each of the flat gears 19 formed on the moving frame 14 and each of the flat gears 21 formed on the second moving frame 15, where they are rotated. The moving frame 14 and second moving frame 15 are thus held parallel, and the second moving frame 15 is moved within a plane perpendicular to the optical axis A.

The gears 17 are gears having an approximately cylindrical shape, on which gear teeth are formed with gear traces extending in the axial direction on the outer circumference of the cylinder. The three gears 17 are disposed between each of the drive coils at an interval of 120° in the circumferential direction, and each of the axial lines is disposed in a direction tangential to a circle centered on the optical axis A. In addition, the length in the axial direction of each of the gears 17 is shorter than that of each of the flat gears 19 and flat gears 21 which engage them. Each of the gears 17 is thus held between the flat gears 19 and the flat gears 21 in such a way that they can slide freely in the axial direction.

Also, each of the gears 17 is supported by the gear support member 17a with respect to the fixed plate 12, and constituted to rotate about the gear shafts 17b of the gear support members 17a. The gear support members 17a are wire members bent into approximately a gate-shape; the bottom ends of the leg portions on both sides thereof are respectively attached to the fixed plate 12, and the gears 17 are rotated about the gear shafts 17b between each of the leg portions thereof. The gear shafts 17b are formed to be longer than the length of the gears 17 in the axial direction, and the gears 17 are able to slip freely in the axial direction while rotating about the gear shafts 17b. At the same time, the position of the gear shafts 17b is fixed, and the radial distance between the rotational axis of the gears 17 and the optical axis is fixed.

As a result of the action of these gears 17, the moving frame 14 and the second moving frame 15 are moved in mutually opposing directions. For example, when current flows in each drive coil and a drive force is generated moving the moving frame 14 vertically upward with respect to the second moving frame 15, the moving frame 14 is moved vertically upward by a predetermined distance as the second moving frame 15 is moved by the same distance vertically downward. At this point, the gears 17 disposed at the bottom of the image stabilizing lens 16 are rotated without being moved in the direction of the gear shafts 17b. The vertical upward movement distance of the moving frame 14 is thus made equal to the vertical downward movement distance of the second moving frame 15. At the same time, vertical movement of the moving frame 14 and the second moving frame 15 is allowed by the rotation of the other two gears 17 as they slide in the direction of the respective gear shafts 17b. Thus the moving frame 14 and second moving frame 15 are moved in mutually opposite directions by the action of each of the gears 17. In other words, when the optical axis A of an image stabilizing lens 16 to which a moving frame 14 is attached is moved by ΔX in the horizontal direction and ΔY in the vertical direction, the second moving frame 15 is moved by −ΔX in the horizontal direction and −ΔY in the vertical direction. Thus the moving frame 14 and second moving frame 15 are moved by the same distance in mutually opposite directions.

As shown in FIG. 2 and FIG. 4, a first magnetic sensor 24a, second magnetic sensor 24b, and third magnetic sensor 24c are respectively disposed inside each of the drive coils, thereby measuring deflection in the circumferential direction of each drive coil relative to the corresponding drive magnet. As noted above, the second moving frame 15 to which each drive magnet is attached and the moving frame 14 to which each drive coil is attached are moved in mutually opposite directions, therefore the amount of relative displacement between the drive magnets and the drive coils is twice the amount of displacement of the image stabilizing lens 16. Also, when the moving frame 14 is moved to a position at which the optical axis of the image stabilizing lens 16 matches the optical axis A of the other imaging lenses 8, the relative displacement amounts between each of the drive magnets and each of the drive coils respectively go to zero. The position to which the moving frame 14 translationally moves relative to fixed plate 12 can be identified based on the signals detected by the first, second, and third magnetic sensors 24a, 24b, and 24c. In the present embodiment a Hall element is used as the magnetic sensor.

Next we discuss control of the anti-vibration actuator 10.

Vibration of the lens unit 2 is detected moment by moment by the gyro 34 and input to the controller 36. A computation circuit (not shown) built into the controller 36 generates a lens position command signal which commands as a time sequence the position to which the image stabilizing lens 16 is to be moved, based on the angular velocity input from moment to moment from the gyro 34. By moving the image stabilizing lens 16 from moment to moment in accordance with the lens position command signal obtained in this manner, images focused on the film surface F in the camera body 4 are stabilized even if the lens unit 2 vibrates during exposure of a photograph.

The controller 36 controls the current sourced to the first, second, and third drive coils 20a, 20b, and 20c so that the image stabilizing lens 16 is moved to the position instructed by the lens position command signal generated by the computation circuit (not shown).

The controller 36 sources to each of the drive coils 20 a current proportional to the difference between the amount of movement of each drive coil relative to each drive magnet measured by each magnetic sensor and the lens position command signal. Thus when there ceases to be a difference between the position of the lens commanded by the lens position command signal and the positions detected by each magnetic sensor, current ceases to flow to each drive coil, and the drive force acting on each drive coil goes to zero.

Next, referring to FIG. 1, we discuss the mode of operation of the camera 1 according to an embodiment of the present invention. First, the anti-vibration actuator 10 provided on the lens unit 2 is activated by turning on the switch for the camera 1 anti-shake function (not shown). The gyro 34 attached to the lens unit 2 detects vibration in a predetermined frequency band from moment to moment, outputting this to the computation circuit (not shown) built into the controller 36. The gyro 34 outputs an angular velocity signal to the computation circuit, and the computation circuit time-integrates the inputted angular velocity signal, calculates a deviation angle, and adds a predetermined modifying signal to this to generate a lens position command signal. The image focused on the film surface F of the camera main body 4 is stabilized by moving the image stabilizing lens 16 from moment to moment to positions instructed by the lens position command signal output as a time sequence by the computation circuit.

The controller 36 sources to each drive coil a current responsive to the difference between the detected signal on each of the magnetic sensors and the lens position command signals for each direction. A magnetic field proportional to the current is generated when current flows in the drive coils. As a result of this magnetic field, the first, second, and third drive coils 20a, 20b, and 20c positioned to correspond to the first, second, and third drive magnets 22a, 22b, and 22c respectively receive a drive force, moving the moving frame 14. When the moving frame 14 is moved by the drive force and each drive coil reaches the position designated by the lens position command signal, the drive force goes to zero. If the moving frame 14 departs from the position designated by the lens position command signal due to an external disturbance, or to changes in the lens position command signal or the like, current again flows in the drive coils, and the moving frame 14 is returned to a position designated by the lens position command signal.

By continuously repeating the aforementioned operation at close intervals, the image stabilizing lens 16 attached to the moving frame 14 is moved so as to follow the lens position command signal. The image focused on the film surface F of the camera main body 4 is thus stabilized.

Also, gravity is acting at all times on the moving frame 14 to which the image stabilizing lens 16 is attached, and the moving frame 14 receives a vertically downward directed force, but since the moving frame 14 and second moving frame 15 are moved together via the gears 17 serving as reverse motion mechanism, movement of the moving frame 14 by gravity is prevented. In other words, to move the moving frame 14 downward requires upward movement of the second moving frame 15, which is moved in tandem by the gears 17. The present embodiment is constituted so that the total moving frame 14 mass and the total second moving frame 15 mass are equal, therefore the gravity acting on the moving frame 14 and the gravity acting on the second moving frame 15 balance on both sides of each of the gears 17, and downward movement of the moving frame 14 by gravity can be prevented. Therefore a drive force to hold the moving frame 14 in a predetermined position against gravity is not required, and the drive means constituted by each of the drive coils and drive magnets need only generate a drive force to move the image stabilizing lens 16 relative to the optical axis.

In the anti-vibration actuator 10 of the first embodiment of the present invention, the second moving frame 15 is moved by the gears 17 serving as reverse motion mechanism in a direction opposite the direction in which the image stabilizing lens 16 is moved. Therefore when the moving frame 14 to which the image stabilizing lens 16 is attached is pulled downward by gravity, the gears 17 conversely seek to pull the second moving frame 15 upward. The gravity acting on the moving frame 14 is thus canceled by the gravity acting on the second moving frame 15. The drive force used to hold the image stabilizing lens 16 in a predetermined position against gravity can by this means be reduced. In other words, the drive force generated by sourcing current to each of the drive coils can be minimized and the power consumed by the anti-vibration actuator 10 accordingly reduced.

Since the drive force required to be generated by the drive coils and drive magnets serving as drive means is thus reduced, the drive coils and drive magnets can be reduced in size.

Moreover, in the anti-vibration actuator 10 the total mass of the moving frame 14 and the total mass of the second moving frame 15 are essentially equal, and the distance moved by the moving frame 14 and the second moving frame 15 are also essentially equal, therefore the gravity acting on the moving frame 14 and the gravity acting on the second moving frame 15 are essentially balanced, and the drive force needed to hold the image stabilizing lens 16 in place against gravity can be made extremely small. On the other hand, because the moving frame 14 is supported by the steel balls 18, it can move the image stabilizing lens 16 more smoothly compared to the use of a spring or the like to support the moving frame.

In the anti-vibration actuator 10 of the present embodiment, the gears 17 sandwiched between the moving frame 14 and the second moving frame 15 are used as a reverse motion mechanism, therefore the moving frame 14 and second moving frame 15 can be maintained in parallel at a predetermined gap, while a mechanism is achieved whereby the second moving frame 15 is moved in a direction opposite that of the moving frame 14.

In the above-described first embodiment of the present invention, the gears 17 are furnished with one set of gear teeth extending in the axial direction, but a variation in which the gears are furnished with two or more sets of gear teeth is also acceptable. In the variation shown in FIG. 7, the gears 38 are furnished at both end portions with two pairs of gear teeth 38a and 38b arrayed in the axial direction, and these two sets of gear teeth are linked by a small diameter portion 38c at the center. The two pairs of gear teeth 38a and 38b are mutually offset, and are constituted so that the peak portions of the gear teeth 38a and the valley portions of the gear teeth 38b match, and the valley portions of the gear teeth 38a and the peak portions of the gear teeth 38b match. Note that each of the flat gears (not shown) respectively meshing with the gears 38 are also formed to include two sets of gear teeth of differing phases so as to be able to mesh with the gear teeth 38a and 38b, respectively. Each of the flat gears (not shown) is formed so that the gears 38 can slide by a predetermined distance in the axial direction.

Thus by furnishing the gears with multiple gear teeth of differing phases it is possible in the present variation to minimize torque unevenness arising from gear rotational position, fluctuations in the distance between the moving frame and the second moving frame, and so forth.

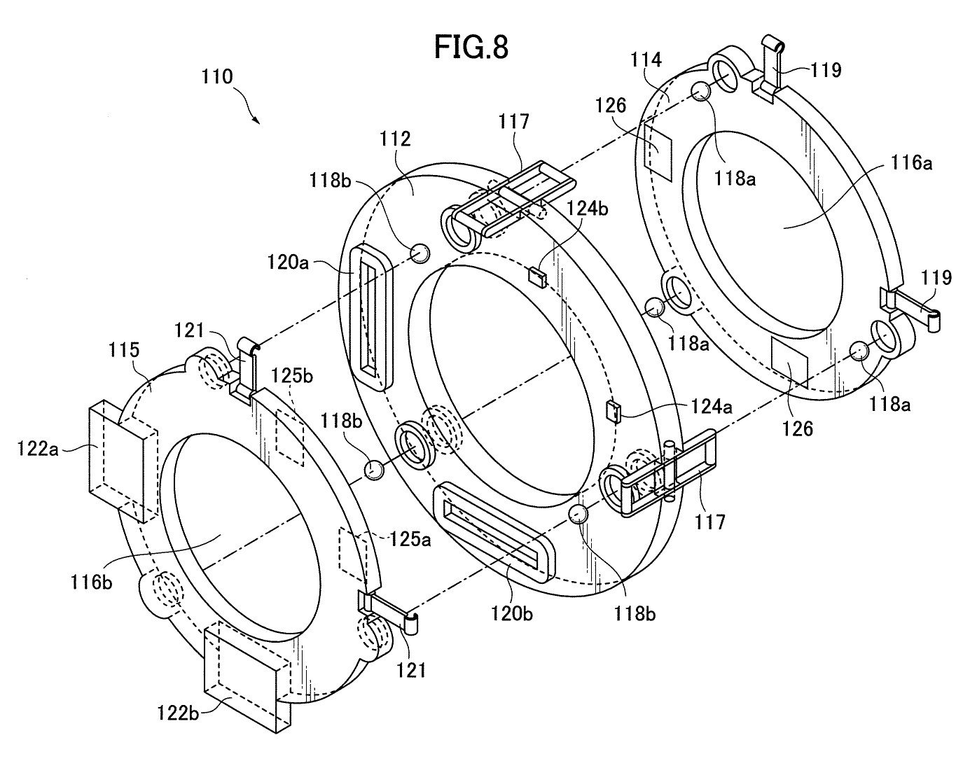

Next, referring to FIGS. 8 through 10, we discuss an anti-vibration actuator according to a second embodiment of the present invention.

In the anti-vibration actuator of the present embodiment, it is primarily the reverse motion mechanism which differs from that described in the first embodiment above. Therefore we will here discuss only those points of the present embodiment which differ from the first embodiment, and will omit a discussion of similar portions.

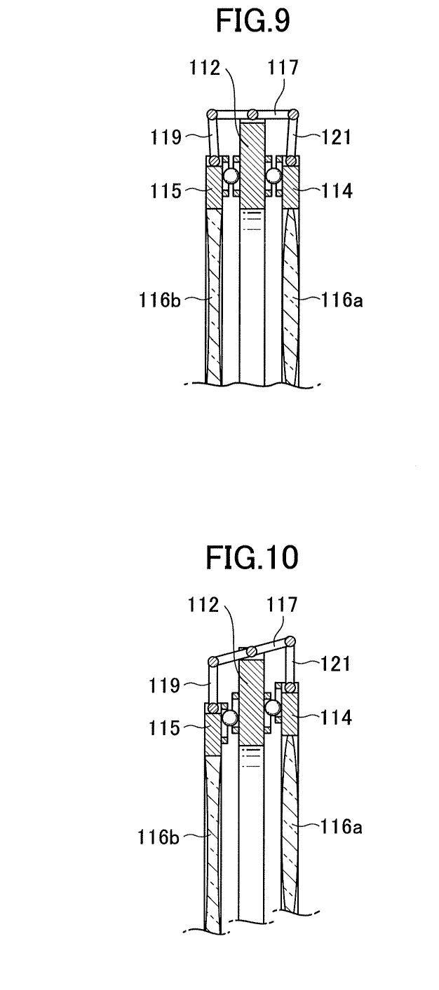

FIG. 8 is an exploded perspective view of the anti-vibration actuator in the second embodiment of the present invention. FIG. 9 is a partial cross-section showing the state of the reverse motion mechanism when the moving frame and the second moving frame have been displaced; FIG. 10 is a partial cross-section showing the state of the reverse motion mechanism when the moving frame and the second moving frame are not being displaced.

As shown in FIG. 8, the anti-vibration actuator 110 has a fixed plate 112, which is a fixed portion affixed inside the lens barrel 6; a moving frame 114, which is a first movable portion disposed to be capable of translational movement relative to this fixed plate 112; three steel balls 118a serving as a movable portion support means for supporting the moving frame 114; a second moving frame 115, which is a second movable portion disposed to be movable relative to the fixed plate 112; three steel balls 118b supporting this second moving frame 115; and two see-saw arms 117 serving as a reverse motion mechanism to move the moving frame 114 and the second moving frame 115 in mutually opposite directions.

Moreover, the anti-vibration actuator 110 has a first drive coil 120a and a second drive coil 120b to which a fixed plate 112 is affixed; a first drive magnet 122a and second drive magnet 122b attached at positions respectively corresponding to the first drive coil 120a and second drive coil 120b on the second moving frame 115; a first magnetic sensor 124a and second magnetic sensor 124b serving as first and second position detection elements respectively disposed on the fixed plate 112; and position detection magnets 125a and 125b disposed at positions corresponding to each of the magnetic sensors on the second moving frame 115.

The anti-vibration actuator 110 also has two attaching yokes 126 attached to the moving frame 114 in order to pull the moving frame 114 and the second moving frame 115 to the fixed plate 112 using the magnetic force of each of the drive magnets. Note that the first drive coil 120a and second drive coil 120b, as well as the first drive magnet 122a and second drive magnet 122b respectively attached at positions corresponding thereto, respectively form drive mechanisms for generating a drive force between the fixed plate 112 and the second moving frame 115, thereby moving an image stabilizing lens 116a and a second image stabilizing lens 116b to a predetermined position.

As shown in FIG. 8, in the anti-vibration actuator 110 the moving frame 114 and the second moving frame 115 are respectively disposed on both sides of the fixed plate 112. An image stabilizing lens 116a consisting of a convex lens is attached to the moving frame 114, and a second image stabilizing lens 116b consisting of a concave lens is attached to the second moving frame 115; these image stabilizing lenses are moved in mutually opposing directions by a reverse motion mechanism. Three steel balls 118a are sandwiched between the moving frame 114 and the fixed plate 112, and three steel balls 118b are sandwiched between the second moving frame 115 and the fixed plate 112; each moving frame is supported so as to be able to move within a plane perpendicular to the optical axis A.

A first drive coil 120a and a second drive coil 120b are attached to the fixed plate 112 so as to form a 90° angle to one another, and a first drive magnet 122a and second drive magnet 122b are respectively disposed at positions corresponding to each drive coil on the second moving frame 115. Thus when current flows in each of the drive magnets, drive force is generated in the interval with the corresponding drive magnets, and the second moving frame 115 is thereby driven relative to the fixed plate 112. When the second moving frame 115 is driven, the moving frame 114 is driven in a direction opposite that of the second moving frame 115 by the reverse motion mechanism. Moreover, attaching yokes 126 are respectively attached to the moving frame 114 at positions corresponding to each of the drive magnets. The second moving frame 115 and the moving frame 114 are thereby pulled to one another, and the steel balls 118b are sandwiched between the second moving frame 115 and the fixed plate 112, while the steel balls 118a are sandwiched between the moving frame 114 and the fixed plate 112.

In addition, the first magnetic sensor 124a and second magnetic sensor 124b are respectively attached to the fixed plate 112. At the same time, a first detection magnet 125a and second detection magnet 125b are respectively attached to the second moving frame 115 at positions corresponding to the first magnetic sensor 124a and the second magnetic sensor 124b. By detecting deflection of the magnetization boundary of the first detection magnet 125a and the second detection magnet 125b, the first magnetic sensor 124a and the second magnetic sensor 124b respectively detect deflection in the horizontal and vertical directions of the second moving frame 115. The position of the second moving frame 115 relative to the fixed plate 112 is thereby detected.

Next, referring to FIGS. 8 through 10, we discuss the reverse motion mechanism according to the second embodiment of the present invention.

In the present embodiment, the reverse motion mechanism comprises: a link mechanism having two see-saw arms 117; two first links 119 linking these see-saw arms 117 with the movable frame 114; and two second links 121 linking each see-saw arm 117 with the second moving frame 115.

The two see-saw arms 117 are frame-shaped members extending in a direction parallel to the optical axis A, respectively disposed vertically upward and horizontally to the side of the optical axis A. The center portion of each of the see-saw arms 117 is rotatably attached to the outer edge portion of the fixed plate 112. Each of the first links 119 is constituted to connect one end portion of each of the see-saw arms 117 to the outer edge portion of the movable frame 114. At the same time, each of the second links 121 is constituted to connect the other end portion of each of the see-saw arms 117 to the outer edge portion of the second movable frame 115. I.e., the movable frame 114 and the second moving frame 115 are respectively linked on both sides of the fulcrum at the center of each of the see-saw arms 117.

The first links 119 are elongated plate-shaped members, one end of which is rotatably linked to the outer edge portion of the movable frame 114, and the other end of which is rotatably linked to the other end portion of the see-saw arms 117. Also, the width of the first links 119 is shorter than the length of the axial portion at the end of the see-saw arms 117, and the first links 119 are slidably linked to the see-saw arms 117. I.e., the first links 119 erected vertically above the optical axis A are connected so as to be slidable in the horizontal direction relative to the axial portion of the linked see-saw arms 117. At the same time, the first links 119 erected on the horizontal side of the optical axis A are connected so as to be slidable in the vertical direction relative to the axial portion of the linked see-saw arms 117. The movable frame 114 is thereby made capable of translational movement in any desired direction relative to the fixed plate 112.

Similarly, the second links 121 are elongated plate-shaped members, one end of which is rotatably linked to the outer edge portion of the second moving frame 115, and the other end of which is rotatably linked to the other end portion of the see-saw arms 117. Also, the width of the second links 121 is shorter than the length of the axial portion at the end of the see-saw arms 117, and the second links 121 are slidably linked to the see-saw arms 117. I.e., the second links 121 erected vertically above the optical axis A are connected so as to be slidable in the horizontal direction relative to the axial portion of the linked see-saw arms 117. At the same time, the second links 121 erected on the horizontal side of the optical axis A are connected so as to be slidable in the vertical direction relative to the axial portion of the linked see-saw arms 117. The second moving frame 115 is thereby made capable of translational movement in any desired direction relative to the fixed plate 112.

Each of the first links 119 and second links 121 is connected at both end portions of each of the see-saw arms 117, therefore the movable frame 114 and the second moving frame 115 are moved in mutually opposite directions. Moreover, each of the see-saw arms 117 is rotatably attached at its center portion to the fixed plate 112, so the distances from the center portion to the ends on both sides of the see-saw arms 117 are equal, and the moving distance of the movable frame 114 and the second moving frame 115 become equal. The movable frame 114 and the second moving frame 115 are thus moved in mutually opposite directions, and image stabilizing lenses 116a (convex lens) and image stabilizing lens 116b (concave lens), which have inverse optical powers (reciprocal of the focal length of lens), are respectively attached. Therefore the effect of moving an image formed on a film surface relative to movement of the movable frame 114 by the same distance is double that when only one of the two image stabilizing lenses is used. Thus a large image stabilizing effect can be obtained from a very small amount of movement of the movable frame 114 and the second moving frame 115.

Note that the distance in the direction parallel to the optical axis A between the two end portions of the see-saw arms 117 changes between the state in which each of the image stabilizing lens is being moved (FIG. 9) and the state in which they are not being moved (FIG. 10). However, rotational movement can occur between the movable frame 114 and each of the first links 119, and between the second moving frame 115 and each of the second links 121, and steel balls are respectively sandwiched between the fixed plate 112 and the movable frame 114 and between the fixed plate 112 and the second moving frame 115, therefore the movable frame 114 and the second moving frame 115 are translationally moved in any desired direction, while parallelness is maintained over a fixed gap.

In the anti-vibration actuator 110 of the second embodiment of the present invention, the reverse motion mechanism is constituted by a link mechanism, therefore the reverse motion mechanism can be achieved using a simple structure.

Also, in the above-described second embodiment of the present invention, the center portion of the see-saw arms 117 is attached to the fixed plate 112, and the movable frame 114 and second moving frame 115 are moved the same distance, but it is also possible as a variation to adopt differing lengths for both sides of the see-saw arms. In the variation thus constituted, the movement distances of the movable frame 114 and the second moving frame 115 differ, but even when the movable frame 114 and second moving frame 115 have different masses, the gravity acting on them can be balanced by adjusting the length on both sides of the see-saw arms.

We have explained preferred embodiments of the present invention above, but various changes may be made to the above-described embodiments. In particular, in the embodiments described above the present invention was applied to a film camera, but the present invention may also be applied to any desired still or moving picture camera, such as a digital camera, a video camera, or the like. The present invention may also be applied to lens units used together with the camera bodies of such cameras.

### EXPLANATION OF REFERENCE NUMERALS

1 Camera according an embodiment of the present invention
2 Lens unit
4 Camera body
6 Lens barrel
8 Imaging lenses
10 Anti-vibration actuator
12 Fixed plate (fixed portion)
14 Moving frame (first movable portion)
15 Second moving frame (second movable portion)
16 Image stabilizing lens
17 Gears (reverse motion mechanism)
17a Gear support member
17b Gear shaft
18 Steel balls (movable portion support means)
19 Flat gear
20a First drive coil
20b Second drive coil
20c Third drive coil
21 Flat gear
22a First drive magnet
22b Second drive magnet
22c Third drive magnet
24a First magnetic sensor (first position detection element)
24b Second magnetic sensor (second position detection element)
24c Third magnetic sensor (third position detection element)
26 Attracting yoke
30 Steel ball holder
31 Steel ball holder
34 Gyro
36 Controller (control section)
38 Gear
110 Actuator according to a second embodiment of the present invention
112 Fixed plate (fixed portion)
114 Moving frame (first movable portion)
115 Second moving frame (second movable portion)
116a Image stabilizing lens
116b Image stabilizing lens
117 See-saw arms (reverse motion mechanism)
118a Steel balls (movable portion support means)
118b Steel balls (movable portion support means)
119 First link
120a First drive coil
120b Second drive coil
121 Second link
122a First drive magnet
122b Second drive magnet
124a First magnetic sensor
124b Second magnetic sensor
125a Position detecting magnet
125b Position detecting magnet
126 Attracting yoke

1. An anti-vibration actuator for moving an image stabilizing lens, comprising:
a fixed portion;
a first movable portion, to which the image stabilizing lens is attached, disposed to be movable within a plane perpendicular to an optical axis of the image stabilizing lens;
a second movable portion, disposed to be movable with respect to the fixed portion;
movable portion support means for supporting the first movable portion or second movable portion such that they can move within a plane perpendicular to the optical axis;
drive means for generating a drive force so as to move the image stabilizing lens to a predetermined position within a plane perpendicular to the optical axis; and
a reverse motion mechanism for moving the second movable portion in a direction opposite the direction in which the image stabilizing lens is moved when the image stabilizing lens is moved to a predetermined position within a plane perpendicular to the optical axis.

2. The anti-vibration actuator of claim 1, wherein the reverse motion mechanism moves the first movable portion and second movable portion in opposite directions by a essentially the same distance.

3. The anti-vibration actuator of claim 1, wherein the first movable portion and second movable portion have essentially the same mass.

4. The anti-vibration actuator of claim 1, having a second image stabilizing lens attached to the second movable portion; whereby this second image stabilizing lens has an optical power inverse to that of the image stabilizing lens.

5. The anti-vibration actuator of claim 1, wherein the reverse motion mechanism comprises gears disposed between the first movable portion and the second movable portion.

6. The anti-vibration actuator of claim 1, wherein the reverse motion mechanism comprises a link mechanism, and the first movable portion and second movable portion are respectively coupled on both sides of the fulcrum of the link mechanism.

7. A lens unit furnished with an image stabilizing mechanism, comprising:
a lens barrel;
an imaging lens disposed inside the lens barrel; and
the anti-vibration actuator of claim 1.

8. A camera furnished with an image stabilizing mechanism, comprising:
a camera body; and
the lens unit of claim 7.
